(19) United States
(12) Patent Application Publication
(10) Pub. No.: US 2007/0036697 A1
(43) Pub. Date: Feb. 15, 2007

(54) Multi-zone jacketed pipe reactor for carrying out exothermic gaseous phase reactions

(76) Inventors: Friedrich Gutlhuber, Metten (DE); Manfred Lehr, Deggendorf (DE); Gunnar Heydrich, Limburgerhof (DE); Gunther Windecker, Ludwigshafen (DE); Stephan Schlitter, Limburgerhof (DE); Michael Hesse, Worms (DE); Markus Rosch, Oppenheim (DE); Alexander Weck, Freinsheim (DE); Rolf Hartmuth Fischer, Heidelberg (DE)

Correspondence Address: MILDE & HOFFBERG, LLP, 10 BANK STREET, SUITE 460, WHITE PLAINS, NY, 10606, US

(21) Appl. No.: 10/482,398

(22) Filed: Dec. 31, 2003

(30) Foreign Application Priority Data
Jan. 31, 2003 (WO) PCT/EP03/00978

(51) Int. Cl. B01J 19/00; F28D 21/00

(52) U.S. Cl. 422/202

(57) ABSTRACT

A multi-zone jacketed pipe reactor (2; 60; 90; 130) for carrying out exothermic gaseous phase reactions and with at least one reaction zone (I) working with vaporisation cooling, at least one reaction zone (II) working with circulation cooling and, possibly, with additional zones (III, IV) is characterised in that one reaction zone (I) working with vaporisation cooling forms the first reaction zone to which is connected an additional reaction zone (II) working with circulation cooling. In this way there occurs at the beginning of the reaction, when the latter is most violent, very intensive cooling at a precisely controllable temperature and especially as well a temperature that is constant across the entire cross-section of the reactor while subsequently in a subsequent reaction zone working with circulating cooling by means of global counter-flow guidance of the heat transfer agent a constant cooling of the reaction gas is achieved.

The invention relates to a multi-zone jacketed pipe reactor for carrying out exothermic gaseous phase reactions according to the generic term of Patent Claim 1.

In DE 100 21 986 A1 provisions have already been made, in oxidation processes with considerable reaction heat in connection with combating a risk that the reaction product gas mixture will ignite, to achieve a desired temperature passage throughout the reaction piping by having the relevant pipe reactor subdivided on the heat transfer agent side by means of a separator plate into two successive zones of which one is operated as the vaporisation zone with a heat transfer agent vaporised by the absorption of heat. Such an operation with a jacketed pipe reactor is in principle already known from EP 0 532 325 B1. In this case it is a matter of recovering ethylene oxide, a process that occurs at a relatively low temperature. Accordingly water is used as the heat transfer agent. The reactor in question contains only one reaction zone to which an after cooling zone, permeated with the water to be circulated, is connected.

According to DE 100 21 986 A1 (see above) when reaction product gas enters from below, the first zone in which the reaction proceeds most violently is run with circulation cooling using the same heat transfer agent as the vaporisation zone proceeding upwards which, in doing so, is pushed through a cooler by means of a circulation pump while it heats up in the reactor as it moves away from the point where gas enters. In the vaporisation zone, however, which does without a cooler or a circulation pump, a constant heat transfer agent temperature of necessity ensures corresponding to the heat transfer agent temperature in the first zone. The vapour generated in the vaporisation zone is separated in a separator (steam separation drum or flash drum) from the non-vaporised heat transfer agent which is recycled at the beginning of the second zone while the vaporised heat transfer agent is replaced by liquid heat transfer agent fed into the first zone from the outside.

But there are also other processes, in particular hydration ones such as recovery of butandiol or tetrahydrofuran produced from maleic acid anhydride as well as certain oxidation processes such as the production of acetic acid, methanol and ethylene oxide requiring at least at the beginning maintaining a very precise temperature in order to be carried out rationally. Such a temperature cannot be achieved with a circulating cooling system even with extremely high circulation quantities and concomitantly high investment and operating costs despite all the possible support measures as provided for, for instance, in the PCT application PCT/EP02/14187 dated 12 Dec. 2002. In addition, the reaction temperature is so low that disengaging heat by means of steam generation via a cooler would, due to the insignificant difference in temperature, require an enormously large cooler surface and concomitantly high investment costs. And even then the steam produced in this way would be of relatively inferior quality due to its low temperature and concomitantly low pressure.

Here the invention hopes to provide relief. It is therefore based on the task of creating a rationally operating jacketed pipe reactor for exothermic gaseous phase reaction processes at a relatively low temperature that must be kept at a precise level, at least in the beginning.

This problem is largely solved by the invention with the features described in Claim 1. The subclaims use this as a point of departure to indicate advantageous embodiment options.

By designing the first reaction zone as a vaporisation zone, there, at the beginning of the reaction, a very precisely controllable temperature must be maintained, but most especially one that even at high heating surface loads is completely constant across the entire cross-section of the pipe bank. In addition, it obviates a cooler together with a circulation pump, a relatively repair and maintenance intensive component. The vapour collecting, normally steam from water, can be removed directly and is accordingly under high pressure and thus thermodynamically valuable. With its pressure its temperature and thus the temperature of the two-phase mixture in the relevant reaction zone as well can be very precisely controlled in a simple manner.

Where the subsequent after-reaction zone is run with the same heat transfer agent, exact insulation at the separator plate between them is not necessary even if the heat transfer agent pressure in that zone has to be maintained at a higher level to ensure that vaporisation does not occur in the circulation pump. If required, both zones can deliberately communicate with each other. Thus, for instance, heat transfer agent administration to replace the steam led off from the first reaction zone can be accomplished via the subsequent zone in order to simultaneously heat up the heat transfer agent administered while the after-reaction zone in question, in particular in the direction of the reaction product gas exit, is intensely cooled down by the heat transfer agent fed in there.

Below several exemplary embodiments are described on the basis of the Figures provided. They show the following:

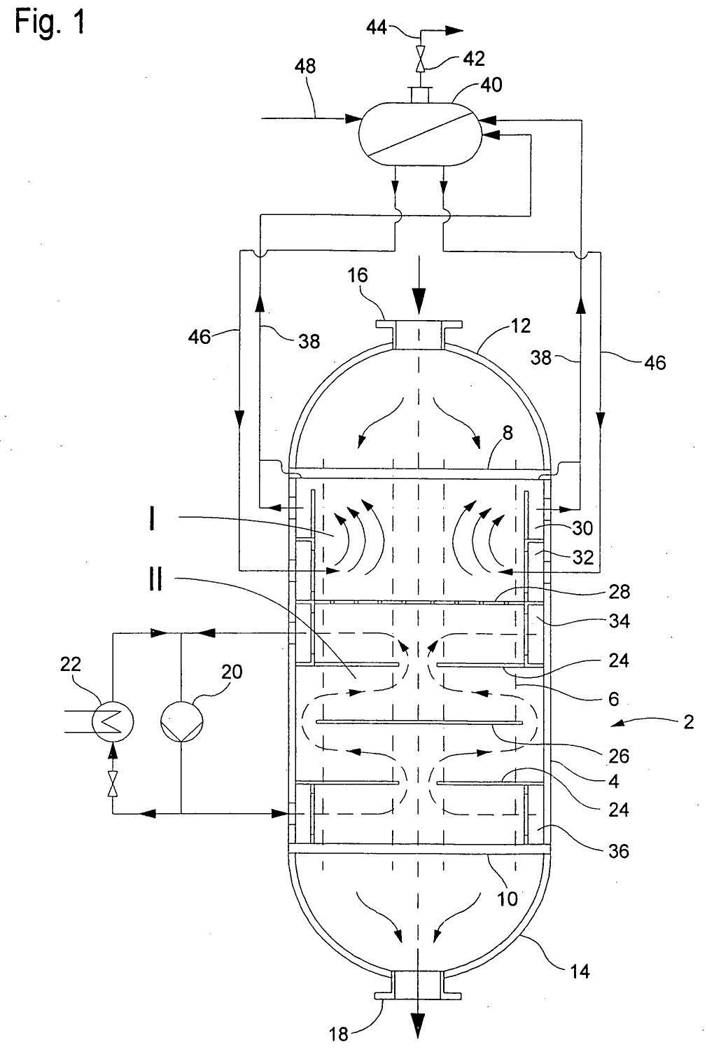

FIG. 1 (schematically in a longitudinal section) shows an embodiment of a jacketed pipe reactor according to this invention with a first so-called vaporisation zone in relation to the process gas flow and a subsequent after-reaction zone working with heat transfer agent circulation together with connected components shown here only in the manner of a printed circuit.

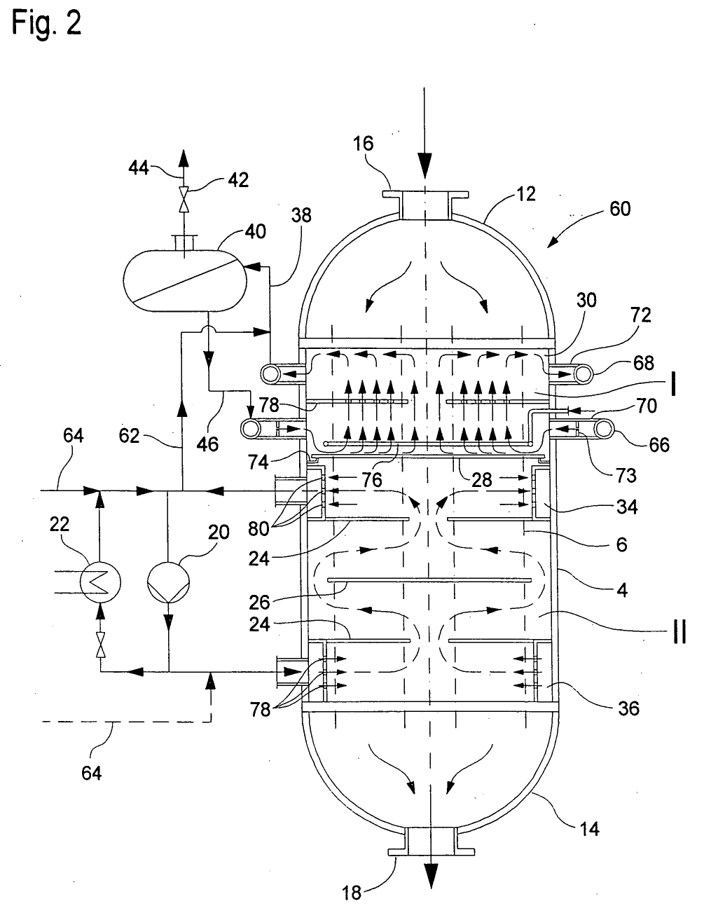

FIG. 2 shows a similar jacketed pipe reaction together with connected components with several modifications and additional details having the two heat transfer agent loops deliberately communicate with each other.

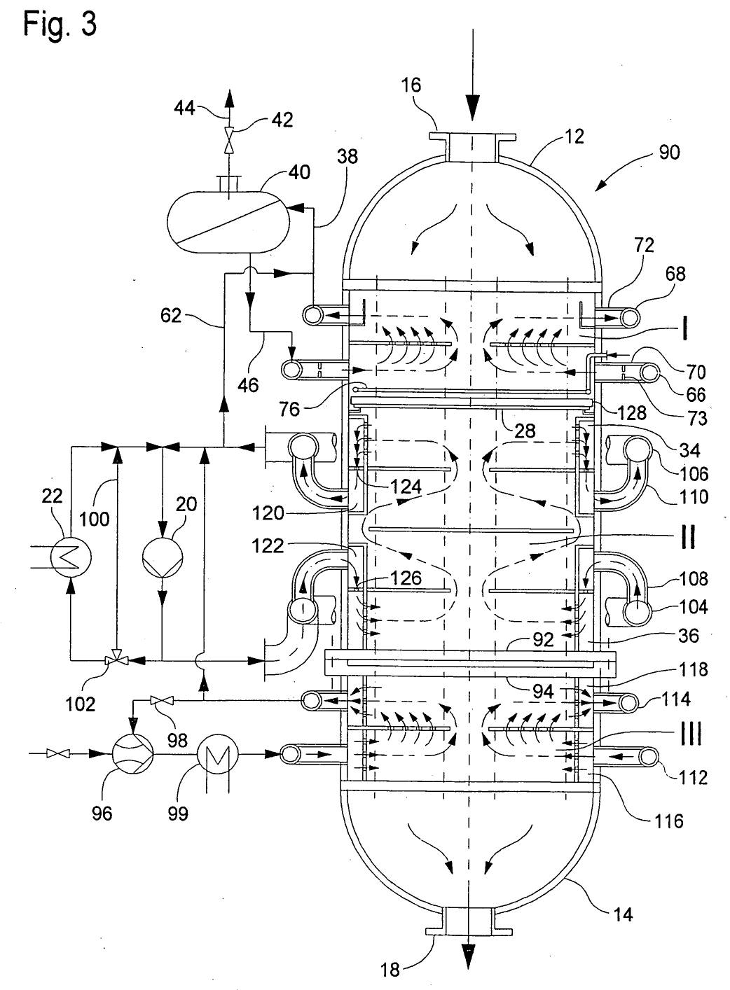

FIG. 3 shows a similar jacketed pipe reactor, etc as in FIG. 2, but with an after-cooling zone subsequent to the second zone, i.e. the after-reaction zone, through which in this case heat transfer agent feed-in is accomplished, and

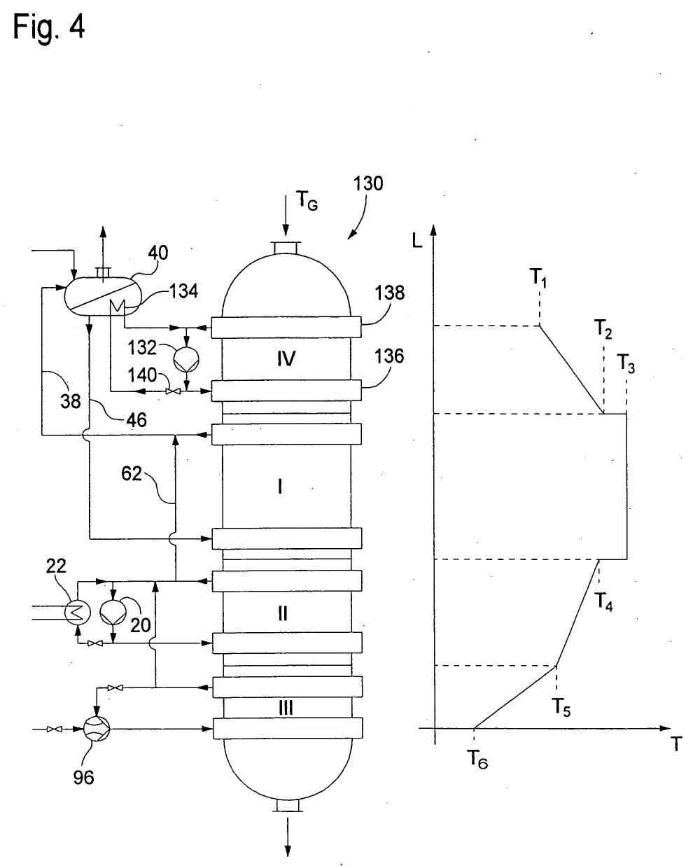

FIG. 4 shows an outside view of an altogether four-zone jacketed pipe reaction according to the invention with connecting components where the first reactor zone is a pre-heating zone for the process gas entering and the final zone is an after-cooling zone for process gas exiting.

The jacketed pipe reactor shown in FIG. 1 shows an upright cylindrical reactor jacket 4 surrounding a hollow cylindrical reaction pipe bank 6 (suggested here only by outer and inner broken limitation lines). The pipe bank 6 extends, sealed in at that point, between two pipe floors 8 and 10. The pipe floors 8 and 10 are overarched by a gas entry hood 12 (here lying on top) or a gas exit hood 14 for the process gas led in or off via pipe sockets 16 and 18, the process gas reacting in the pipes of pipe bank 6 by means of a catalyst filling located therein. To lead off the reaction heat generated by this and to control the pipe wall temperature in a manner required for the process in question the pipes are surrounded in the inside of the reactor jacket 4 by an essentially liquid heat transfer agent giving off into the outside excess heat absorbed by the pipes. For this purpose, the heat transfer agent is usually circulated by means of a circulation pump (like the circulation pump 20 shown here) on the one hand through the reactor jacket and on the other hand through a cooler (like the cooler 22 shown here) in which steam is recovered from the heat given off there. In order to be able to achieve in that particular reactor or reactor section turbulent heat transfer agent flow as well as (throughout the pipes) a desired temperature profile for the purpose of better heat transition, inside the reactor jacket 4 alternating ring and disk-shaped baffle plates infiltrated by at least an essential portion of the pipes, like the baffle plates 24 and 26 shown here, are provided which however for a desired flow distribution have penetration openings of variable cross-sections (so-called partial flow openings) around the pipes and/or between them and which, where required, can also serve to stabilise the pipes against vibration. The cooler can, as shown here, be laid out in a valve-controlled bypass loop alongside the main heat transfer agent circuit including the circulation pump 20 and the reactor 2, in order in this way to be able to control the quantity of heat to be led off via the cooler and thus be able to control the process temperature occurring in the reactor. In order to be able to achieve as even a distribution of the heat transfer agent entering and exiting as possible around the circumference of the reactor, lead-off and feed-in of the heat transfer agent is accomplished on the reactor via the ring channels on the reactor jacket 4. All of these measures are nowadays conventionally used to attain desirable process temperature control, etc. It is likewise just as usual to provide bypass routes (so-called bypasses) for the heat transfer agent for even more effective temperature control to remove and/or add additional ring channels at intervening points over the length of the pipe or even to subdivided the reactor into several successive zones by means of more or less insulating separator plates with each zone having its own heat transfer agent circuits as this is approximately described in DE-A-2 201 528 or WO 90/06807.

In accordance with the invention and with FIG. 1, an initial reaction zone I in respect of the process gas running through the reactor 2 is run with vaporisation cooling while a subsequent second reaction zone II operates in the conventional manner with circulation cooling. Both zones, I and II, are separated from each other by a separator plate 28 just as the two cooling systems are separated from each other. Due to the high pressure occurring in such cooling systems (as an example, steam pressure of water at 290° C. is about 70 bar, even at 190° C. hot water is still 15 bar), the pipe floors and the reactor jacket must be relatively strongly constructed while the ring channels (in this case: ring channels 30, 32, 34 and 36) are as shown appropriately placed in the inside of the reactor jacket where they are not subject to any appreciable difference in pressure. Accordingly, the ring channels can also, as shown by ring channel 30, by contrast to conventional ring channels, generally be opened up to the inside of the jacket around it.

The steam generated in reaction zone I is fed as a steam-water mixture via risers 38 (which must consequently be voluminous) to a flash drum 40 located above the reactor 2 from where it is led off through a steam pipe 44 containing a continuously adjustable valve 42 into, for instance, a conventional steam system. Via the valve 42 the steam pressure (and thus the heat transfer agent temperature prevailing in the entire reaction zone I) can be controlled very precisely. The water deprived of its steam content in the flash drum 40 flows back via the down-pipes 46 and the ring channel 32 into the reactor jacket. In doing so, the cycle is kept simple through gravity since the steam content in the heat transfer agent rising up through the pipes 38 drives the latter upwards through the pipes 38 due to its lower specific weight.

Heat transfer agent given off as steam by the flash drum 40 is constantly replaced by feed water fed through a feed pipe 48 into the flash drum. The latter can be preheated there with a portion of the steam being let off which it condenses by doing so. In addition, the feed water can in a well-known manner be sprayed in via a sparging device (not shown) in order to avoid sectional undercooling of the water entering the downpipe 46. For complete separation of steam from the liquid phase, the flash drum 40 can be provided with its own separator, in the simplest case consisting of one or more impact plates. Corresponding designs of a flash drum are well known and therefore need no further description here.

Where the separator plate 28 is completely tight (insulation around the pipes can be achieved by widening the pipes in the vicinity of the pipe duct, as indicated moreover in DE-A-2 201 528) both reactor zones I and II can, if so required, be run with different heat transfer agents. In the usual case, however, the same heat transfer agent will be chosen so that its vapours immediately, possibly after choking, can be fed into an operationally conventional steam system.

Near the pipe floor 8 a portion of the steam-water mixture generated in the first reaction zone I at first serves to heat up the incoming reaction product gas quickly until it reaches reaction temperature. By designing the reaction zone I as a vaporisation zone optimum cooling can be then reached with very precise temperature control at the beginning of the reaction when the latter is the most violent. On the other hand, in the subsequent reaction zone II, even where the same heat transfer agent is employed, a lower temperature can be set as can a temperature gradient in the direction of process gas exit as well by having the heat transfer agent moved through the circulation pump 20 cooled accordingly with the partial flow moved through the cooler 22. This mode of operation in zone II is even possible if the two zones I and II communicate with each other via the heat transfer agent source, as will be explained below in FIG. 2.

FIG. 2 shows a reactor designed essentially like the reactor 2 shown in FIG. 1 but with the basic difference that here the two heat transfer circuits are deliberately connected with each other via a pipe 62 leading from the entry side of the circulation pump 20 into a riser 38 and heat transfer agent lost to reaction zone I due to vaporisation is replaced by heat transfer agent fed into the heat transfer agent circuit of reaction zone II via a feed pipe 64, more precisely stated in front of or (illustrated by broken lines) behind the circulating pump 20. In this context the heat transfer agent fed in in this way in zone II contributes to cooling while it heats up itself in the manner desired. Likewise in the flash drum 40 a high temperature is avoided and any undercooling of the heat transfer agent recycled from there through pipe 46.

Wherever in this figure and in additional ones parts occurring are comparable to those in FIG. 1 then they have the same reference numbers.

As shown in FIG. 2 in any case in regard to zone I ring channels, like the inward-lying ring channels 30 and 32 shown in FIG. 1, can if required be dispensed with by having feed-in and lead-off of the heat transfer agent occur, for instance, from reactor jacket 4 in zone I via the ring-shaped pipes 66 and 68 surrounding the reactor jacket which are connected to the inside of the jacket via a plurality of radial connector pipe sockets 70 or 72. Pipes 66 and 68 as well as pipe sockets 70 and 72 should preferably have a circular round cross-section in order to be resistant to pressure. Where needed they can include, as shown in the pipe sockets 70, choking points 73 for more precise flow distribution.

Going further, FIG. 2 then shows how the separator plate 28 is suspended to equalise differing heat expansion degrees pf reactor jacket 4 and pipe bank 6 on the reactor jacket by means of an expansion compensator 74 in the form of a crimped-back sheet ring and how a ring-shaped sparger pipe can be arranged over the separator plate 28 for administration of steam. The latter primarily makes sense in being able to preheat zone I in the reactor's startup phase before the reaction ensues.

Inside zone I the pipes in pipe bank 6 are propped up with a support plate, a support grate or something similar 78 to stabilise them against vibrations without, for that matter, essentially obstructing the through flow of the heat transfer agent. Concomitantly, ring channels 34 and 36 in reaction zone II as shown in FIG. 2 are connected to the jacket inside zones I and II by two relatively closely neighbouring pipe floors 92 and 94. Accordingly their number, their diameter and their separation can differ from those of the reaction pipes and can even be different from the jacket diameter. Frequently such a subsequent cooler contains fewer pipes than the actual reactor. Where the pipes in cooling zone III, on the other hand, form an immediate continuation of the reaction pipes, the zones II and III can be separated from each other by a separator plate similar to separator plate 28.

In the example in FIG. 3 feed-in of the heat transfer agent is accomplished via an injector pump into cooling zone III in which the heat transfer agent is simultaneously heated up before it moves out of the cooling zone into the heat transfer agent circuits of reaction zones I and II. The injector pump 96 is run with a partial quantity of the heat transfer agent leaving cooling zone III which can be controlled by a valve 98. Under certain circumstances the injector pump can be dispensed with just as it can also be replaced on the other hand by a mechanical pump similar to the circulating pump 20. If needed, the heat transfer agent in each case via several axially superimposed window apertures 80 in order to produce a described flow distribution.

The reactor 90 in FIG. 3 differs from reactor 60 in FIG. 2 primarily by the fact that an additional cooling zone III follows after the second reaction zone II that works with circulation cooling. In cooling zone III no further undesirable reaction takes place. Instead, there especially with sensitive reaction products with rapid falloff below reaction temperature a quick end is achieved to the reaction process. For this reason the pipes inside cooling zone III normally do not contain any catalyst filling either. They can be filled with inert material, especially if they form immediate continuations of the reaction pipes or also contain any metal or ceramic installations known in pipe coolers, such as wire coil, ceramic bodies or something similar in order to promote turbulent gas flow.

In the example shown, the cooling zone III is flanged onto the reaction zone II. This means that the pipes of cooling zone III are separated from the reaction pipes of reaction entry into cooling zone III can also be preceded, as shown here, by a heat exchanger, in particular the cooler 99.

Contrary to FIG. 2 entry of the heat transfer agent fed via cooling zone III into the circuit of zone II in the example in FIG. 3 is accomplished on the entry side of circulating pump 20, approximately where the pipe 62 also connects with zone I. Then in the heat transfer agent circuit in zone II another bypass 100 can be discerned, controllable by valve and connected parallel to the cooler 22, like the one described in detail in the PCT application PCT/EP02/14189 dated 12 Dec. 2002. Such a bypass is supposed, especially and without regard to the quantity of heat to be led off from the cooler 22 in any one instance, to make possible constant pump output of the circulating pump connected with constant flow conditions in the reactor. In the example shown, the partial heat transfer agent flows through the cooler 22 and the bypass 100 are alternately controllable via a joint three-way valve.

As an additional variant when compared with FIG. 2, FIG. 3 now also shows inside the reaction zone II ring-shaped pipes 104 and 106 running around the reactor jacket in addition to the ring channels 34 and 36 lying on the inside. The pipes 104 and 106 which can have an adapted cross-section like the subsequent connector pipe sockets 108 and 110, serve to equalise entry and exit of the flow of the heat transfer agent. Similar ring-shaped pipes, 112 and 114, are likewise provided for in cooling zone III in addition to the ring channels 116 and 118 lying inside there.

For further enhancement of flow distribution in zone II entry and exit of the heat transfer agent are accomplished in relation to the ring channels 34 and 36 via ring-shaped distributor channels 120 and 122 positioned downstream and upstream of the latter and likewise lying inside the reactor jacket 4, which distribution channels communicate with the ring channels 34 and 36 via the choke apertures 124 and 126.

Finally, FIG. 3 shows as an example in zone I in addition to the sparger pipe 76 from FIG. 2 a heat-insulating coating 128 of the separator plate.

The reactor 130 shown in FIG. 4 (outside view only) is, apart from the absence of several optional details such as the bypass 100, different from the reactor 90 in FIG. 3 essentially due to the fact that in front of the first reaction zone I another pre-heating zone IV is provided for for the process product gas entering into the reactor. On the right alongside the reactor 130 the temperature sequence of the heat transfer agent achievable therein over the expanse of the reactor L is depicted diagrammatically. As can be seen, the temperature in the heat transfer agent rises continuously in zone IV from the initial reading of T₁ at the entry of the process product gas up through a reading of T₂ somewhat below the constant temperature T₃ of vaporisation zone I where the reaction starts off and simultaneously proceeds most violently with the greatest degree of heat reaction. Thereafter, in zone II, where the reaction phases out, the heat transfer agent temperature constantly drops from a reading of T₄ below T₃ down to a reading of T₅ which simultaneously constitutes the heat transfer agent temperature at the entry of the process product gas in cooling zone III. In the latter, a constant temperature drop occurs down to a reading of T₆ in the vicinity of the heat transfer agent's feed-in temperature.

In regard to zones I through III this temperature sequence is achieved in the manner already indicated in connection with the reactors 2, 60 and 90. Zone IV once again has a heat transfer agent circulation system that nonetheless adds heat to the flow of the process product gas. For this purpose, in a parallel circuit to the circulating pump in question 132 there enters, by means of a heat exchanger 134 heat transfer agent (being either the same as in zones I through III or a different one) heated up inside the flash drum 40 into the reactor jacket 4 via a ring channel 136 at the gas exit end of zone IV and exits the same via a ring channel 138 at the point where the gas exits zone IV in order to move, globally considered, inside the same in a direction contrary to that of the process product gas. As with the other zones as well, the contact pipes in pipe bank 6 can traverse zone IV in which case zone IV is separated from zone I by a separator plate similar to the one shown as 28. On the other hand, zones IV and I can be separated from each other by the neighbouring pipe floors with zone IV and zone I possibly having different pipe diameters and/or arrangements, something that nevertheless should probably only be resorted to very rarely. In this way or that way the pipes inside zone IV can, apart from the process product gas, be empty, or have a catalyst or an inert material filler in it, include turbulence-stimulating installations and so forth, etc, just like the pipes inside cooling zone III.

As in the case of the heat transfer agent circuit in zone II according to FIG. 1, the partial flow of zone IV heat transfer agent leading through the heat exchangers 134 can be controlled by a valve 140. The heat transfer agent circuits in zones I through III however need not, as shown, be connected with each other. In the first case feed-in to replace the heat transfer agent lost to vaporisation according to FIG. 3 can occur via cooling zone III, in the latter case it must, as in FIG. 1, occur, possibly via the flash drum 40, into the heat transfer agent circuit of the vaporisation zone I.

With less sensitive processes, a separate preheating zone like the zone IV shown in FIG. 4 can be dispensed with. In such a case, the process product gas upon entering zone I can be pre-heated by means of the heat transfer agent there, which can also be accomplished with a steam buffer below the pipe floor 8 (FIG. 1) there.

The preceding description limits itself to the essential parts in each case. Their arrangement can in turn go through many different versions. Any one of the pipe floors or separator plates occurring here, or all of them, can be heat-insulated, as described in detail in DE 198 06 810 A1 in order, most especially, to ensure in the reaction zone I a heat transfer agent temperature which is all in all independent of the zones connected to it.

The global heat transfer agent flow in the various zones need not by any means always be counter to the direction of the process product gas flow. The process product gas itself can also, contrary to the embodiment examples described above, penetrate through the reactor from bottom to top. However, leading gaseous flows through from top to bottom in connection with this invention has advantages since the flash drum is generally laid out above the reactor—laterally or centred—and the naturally very voluminous riser piping leading into it, like the risers 38 according to FIG. 1, are preferably kept short. Contrary to the merely schematic presentation in FIGS. 1 through 4, circulating pumps and coolers can generally be laid out on the floor in order to counter in this way a tendency to cavitation.

If required, additional reaction zones and so forth can be added to the reaction zones I and II, operating with or without vaporisation cooling.

What is claimed is:

1. In a multi-zone jacketed pipe reactor for carrying out exothermic gaseous phase reactions having at least one reaction zone (I) working with vaporization cooling using a heat transfer agent, at least one reaction zone (II) working with circulation cooling, and possibly additional reaction zones (III, IV), the improvement wherein said one reaction zone (I) working with vaporization cooling forms a first reaction zone to which an additional reaction zone working with vaporization cooling or with circulation cooling is connected.

2. Multi-zone jacketed pipe reactor according to claim 1, wherein the pressure of the steam accumulating in the respective reaction zone, working with vaporization cooling, and thus the heat transfer agent temperature occurring there as saturated steam temperature, is controllable.

3. Multi-zone jacketed pipe reactor according to claim 1, wherein the heat transfer agent in at least one reaction zone (I) working with vaporization cooling is water, the steam of which exits directly into a conventional steam system.

4. Multi-zone jacketed pipe reaction according to one claim 1, wherein at least one reaction zone (II, IV) immediately connected to a reaction zone (I) working with vaporization cooling works with the same heat transfer agent.

5. Multi-zone jacketed pipe reactor according to claim 4, wherein the relevant zones (I, II, IV) communicate with each other via a heat transfer agent source.

6. Multi-zone jacketed pipe reactor according to claim 5, wherein the heat transfer agent led off as steam is replaceable throughout with liquid heat transfer agent through one of the zones (II-IV) communicating with the respective reaction zone (I).

7. Multi-zone jacketed pipe reaction according to claim 6, wherein at least one of the reaction zones (I) working with vaporisation vaporization cooling is connected to a flash drum.

8. Multi-zone jacketed pipe reactor according to claim 7, wherein the flash drum is arranged above the respective reaction zone (I) and circulation of the vaporizing heat transfer agent between them is accomplished solely through the force of gravity.

9. Multi-zone jacketed pipe reactor according to claim 7, wherein the heat transfer agent replacing the heat transfer agent led off as steam is fed into the flash drum.

10. Multi-zone jacketed pipe reactor according to claim 9, wherein the flash drum comprises a sparging device for the heat transfer agent fed in.

11. Multi-zone jacketed pipe reactor according to claim 6, wherein the liquid heat transfer agent replacing heat transfer agent led off as steam is fed in through a cooling zone (III).

12. Multi-zone jacketed pipe reactor according to claim 1, wherein feeding in of the heat transfer agent occurs via an injector pump operated by a partial flow of the circulated heat transfer agents.

13. Multi-zone jacketed pipe reactor according to claim 1, wherein at least one zone (I-IV) has, for feed-in and/or lead-off of the heat transfer agent, at least one ring channel lying inward in relation to the reactor jacket.

14. Multi-zone jacketed pipe reactor according to claim 13, wherein the ring channel is substantially open to the inside of the jacket around it.

15. Multi-zone jacketed pipe reactor according to claim 1, wherein at least one zone (I-IV) has, for the feed-in and/or of the heat transfer agent, at least one ring-shaped pipe surrounding the reactor jacket, which pipe is in contact with the inside of the jacket via connector pipe sockets regularly distributed across the extent of the jacket.

16. Multi-zone jacketed pipe reactor according to claim 15, wherein the connector pipe sockets contain at least partial choke apertures.

17. Multi-zone jacketed pipe reactor according to claim 15, wherein at least one ring-shaped pipe is connected to an inward lying ring channel.

18. Multi-zone jacketed pipe reactor according to claim 17, wherein the ring-shaped pipe communicates with the relevant inward lying ring channel via a ring-shaped distributor channel likewise lying within the reactor jacket and connected to the inward lying ring channel and via a plurality of choke openings.

19. Multi-zone jacketed pipe reactor according to claim 1, wherein at least one of the zones (II) working with circulation cooling has a cooler (22) lying within a circuit running parallel to the respective heat transfer agent circuit.

20. Multi-zone jacketed pipe reactor according to claim 19, a controllable bypass is arranged parallel to the cooler.

21. Multi-zone jacketed pipe reactor according to claim 1, wherein at least one pair of adjacent zones (I, II, III, IV) are heat-insulated in relation to each other.

22. Multi-zone jacketed pipe reactor according to claim 1, wherein at least one pair of adjacent zones (I, II, III, IV) are separated from each other by a separator plate which is connected with a reactor jacket via an expansion compensator with the effect of reducing radial expansion pressure.

23. Multi-zone jacketed pipe reactor according to claim 1, wherein at the end, where a heat transfer agent enters at least one of the zones (I, II, III, IV), one feeder pipe is arranged for feeding in preheating steam of the respective heat transfer agent.

24. Multi-zone jacketed pipe reactor according to claim 1, wherein the direction of flow of the heat transfer agent in at least one zone (II; III) working with circulation cooling is opposite to the flow direction of the process product gas.
